(19) United States
(12) Patent Application Publication
(10) Pub. No.: US 2025/0219184 A1
(43) Pub. Date: Jul. 3, 2025

(54) Battery Thermal Management Systems and Methods

(71) Applicant: Georgia Tech Research Corporation, Atlanta, GA (US)

(72) Inventors: Deepak M. Divan, Atlanta, GA (US); Joseph Benzaquen Sune, Atlanta, GA (US); Zheng An, Atlanta, GA (US); Brandon Royal, Atlanta, GA (US)

(21) Appl. No.: 18/849,452

(22) PCT Filed: Mar. 21, 2023
(86) PCT No.: PCT/US2023/064766

§ 371 Date: Sep. 20, 2024

Related U.S. Application Data
(60) Provisional application No. 63/321,926, filed on Mar. 21, 2022.
(60) Provisional application No. 63/399,781, filed on Aug. 22, 2022.

(51) Int. Cl. H01M 10/613; H01M 10/6551; H01M 10/6563; H01M 10/6572; H01M 10/658; H01M 50/213; H01M 50/477

(52) U.S. Cl. CPC H01M 10/613; H01M 10/6551; H01M 10/6563; H01M 10/6572; H01M 10/658; H01M 50/213; H01M 50/477

(57) ABSTRACT

An exemplary embodiment of the present disclosure provides a battery system comprising one or more battery modules, one or more thermal conduits, and one or more thermoelectric coolers. Each of the one or more battery modules can comprise a plurality of battery cells. The one or more thermal conduits can be coupled to the one or more battery modules. The one or more thermoelectric coolers can be coupled to the one or more thermal conduits. The one or more thermal conduits can be configured to allow thermal energy to flow from the one or more battery modules to the one or more thermoelectric coolers. The thermoelectric coolers can be configured to dissipate thermal energy received from the one or more battery modules via the one or more thermal conduits.

### CROSS-REFERENCE TO RELATED APPLICATIONS

This application claims the benefit of U.S. Provisional Application Ser. No. 63/321,926, filed on 21 Mar. 2022, and U.S. Provisional Application No. 63/399,781, filed on 22 Aug. 2022, which are incorporated herein by reference in their entireties as if fully set forth below.

### FIELD OF THE DISCLOSURE

The various embodiments of the present disclosure relate generally to batteries and more particularly for systems and methods for managing thermal energy in batteries.

### BACKGROUND

The growth of PV solar and battery technologies has created an enormous demand for clean energy. The non-dispatchability and poor grid integration of PV solar is driving the need for energy storage on the grid. Recently, the idea of hybrid PV solar, where storage is integrated with PV solar farms, has been seeing increasing interest. Most such applications have looked at distinct PV and storage solutions, typically integrated on the grid side, with a typical realization shown in FIG. 1. The need to realize compact energy storage modules, with integrated battery and thermal management, has driven such a strategy. Typical energy storage solutions are modular, including the use of containers, for larger systems. Such modules are generally stacked together to realize larger utility-scale systems. The higher energy-density batteries available today tend to use Lithium chemistry and require precision thermal management to ensure that batteries do not overheat and cause fires. These batteries also tend to suffer high degradation in life if the temperature of the batteries is not maintained in a tight range.

As an alternative approach, a few solutions are now beginning to look at integrating PV solar and battery energy storage at a panel level. The benefits of such integration are well known, but the implementation has been problematic and expensive. A typical approach that has been used is the use of phase change materials (PCM) to allow the regulation of the battery temperature to say 40° C., even as the ambient temperature heats up beyond that. While such an approach is “passive,” it still involves significant cost and results in battery packs that are large and expensive because of the deep integration needed between PCM and individual batteries. More importantly, the PCM used can only absorb a limited amount of energy before it changes state, after which it cannot protect the battery. For instance, the use of the battery pack in a location where the lowest temperature remains above the phase change temperature would make the battery unusable and would degrade its life. There is a similar requirement to maintain the battery temperature above a specific value, if degradation in battery performance and life is to be avoided, which the PCM cannot help with. Finally, the need to design a solution that can operate for 10-20 years without maintenance poses a major challenge that cannot be met with conventional cooling strategies. Most designs, especially of larger rated systems, use complex cooling strategies involving refrigerants and fans, all of which need to be maintained in the field at a high cost.

There is another major challenge that needs to be addressed in the design of grid-connected energy storage systems. Lithium chemistry batteries, especially the Lithium-Ion type, and to a lesser extent, even the Li—Fe—P batteries, can get overloaded with high currents due to failures inside individual cells. This can lead to local overheating and thermal runaway, resulting in explosive venting of the battery and neighboring cells. The tendency to pack large energy storage modules, with as much as 1-MWh with 50,000 Li—Fe—P cells in one module, and a hundred such modules closely packed together on one site-all to achieve higher energy/power density-creates a potential fire hazard, one that is destructive and difficult to control. With so many battery cells in a highly dense and compact system, it is not surprising that the explosive venting of a single battery can start a chain reaction and cause destruction. This has become a major issue for automotive and grid energy storage systems.

Finally, battery packs should be closely managed so that individual cells do not get overheated or lose capacity or life. A typical battery string in an automotive or grid storage application could use 125 to 250 cells in series to realize 400-V or 800-VDC at the battery pack level. Battery management systems are used to monitor individual cell voltage and current levels and to track proper operation. However, given so many cells, different temperature and operating profiles, and manufacturing discrepancies between cells, it is very difficult to ensure the individual cell are uniformly loaded and aging. Managing the voltage across individual cells in a high-voltage stack is possible in principle but is very expensive and rarely done. A 100-kWh/400-VDC battery pack could have 40 such strings in parallel. Controlling current flows between parallel cells or cell stacks may not be possible. To reduce the complexity of the mechanical build and the battery management system, many manufacturers choose to connect many battery cells in parallel before they are connected in series. This arrangement can result in overload of a degraded cell through current flows from other cells and can increase the risk of failure or fire. While each of these design decisions represents a tradeoff between complexity of battery management and battery performance—they all result in the degradation of battery life and increase the danger of explosive venting and fire. For instance, parallel connection of ten cells, quite commonly used, can degrade expected battery life by up to 40%. Accordingly, a different approach is needed for realizing a scalable grid-connected energy storage systems using batteries.

### BRIEF SUMMARY

An exemplary embodiment of the present disclosure provides a battery system comprising one or more battery modules, one or more thermal conduits, and one or more thermoelectric coolers. Each of the one or more battery modules can comprise a plurality of battery cells. The one or more thermal conduits can be coupled to the one or more battery modules. The one or more thermoelectric coolers can be coupled to the one or more thermal conduits. The one or more thermal conduits can be configured to allow thermal energy to flow from the one or more battery modules to the one or more thermoelectric coolers. The thermoelectric coolers can be configured to dissipate thermal energy received from the one or more battery modules via the one or more thermal conduits.

In any of the embodiments disclosed herein, each of the one or more battery modules can further comprise a conductive plate and a support structure. The conductive plate can have first and second sides. At least a first portion of the plurality of battery cells can be positioned adjacent to the first side of the conductive plate. The support structure can be positioned between and in contact with the first portion of the plurality of battery cells and the first side of the conductive plate. The support structure can be configured to assist thermal energy generated by the first portion of battery cells to flow to the conductive plate.

In any of the embodiments disclosed herein, a second portion of the plurality of battery cells can be positioned adjacent to the second side of the conductive plate, each of the one or more battery modules can further comprise a second support structure positioned between and in contact with the second portion of the plurality of battery cells and the second side of the conductive plate, and the second support structure can be configured to allow thermal energy generated by the second portion of battery cells to flow to the conductive plate.

In any of the embodiments disclosed herein, the conductive plate can comprise aluminum.

In any of the embodiments disclosed herein, the battery system can further comprise an insulator surrounding at least a portion of the one or more battery modules.

In any of the embodiments disclosed herein, the insulator can be configured to inhibit the flow of thermal energy between the plurality of battery cells and an external environment to the battery system.

In any of the embodiments disclosed herein, the battery system can further comprise an enclosure defining an interior volume, and the interior volume can contain the one or more battery modules, the one or more thermal conduits, the one or more thermoelectric coolers, and the insulator.

In any of the embodiments disclosed herein, the insulator can have a thermal conductivity of 0.001-0.0025 W/(m·K).

In any of the embodiments disclosed herein, the insulator can comprise an insulative sleeve and side plates.

In any of the embodiments disclosed herein, the side plates can comprise one or more apertures configured to receive the one or more thermal conduits.

In any of the embodiments disclosed herein, the one or more thermoelectric coolers can comprise a Peltier junction.

In any of the embodiments disclosed herein, the battery system can further comprise one or more heat sinks, and the one or more heat sink can be coupled to corresponding thermoelectric coolers in the one or more thermoelectric coolers.

In any of the embodiments disclosed herein, the battery system can further comprise a chamber defining a substantially hollow internal cavity. The chamber can comprise a first opening and a second opening. The first opening can receive a first heat sink of the one or more heat sinks. The second opening can be in fluid communication with an external environment.

In any of the embodiments disclosed herein, the second opening can be located proximate an end of the chamber.

In any of the embodiments disclosed herein, the chamber can further comprise a fan configured to generate airflow through the internal cavity to discharge thermal energy from the heat sinks, through the second opening, and to the external environment.

In any of the embodiments disclosed herein, the battery system can be configured to generate a voltage level in the range of 24 to 48 volts.

Another embodiment of the present disclosure provides a battery system comprising a conductive plate, a first plurality of battery cells, a support structure, a thermal conduit, and a thermoelectric cooler. The first plurality of battery cells can be disposed adjacent to a first side of the conductive plate. The support structure can be positioned between the first side of the conductive plate and the first plurality of battery cells, and the support structure can be configured to assist in the transfer of thermal energy generated by the first plurality of battery cells to the conductive plate. The thermal conduit can be coupled to the conductive plate. The thermoelectric cooler can be coupled to the thermal conduit. The thermal conduit can be configured to allow thermal energy to be transferred from the conductive plate to the thermoelectric cooler. The thermoelectric cooler can be configured to dissipate thermal energy generated by the plurality of battery cells and received at the thermoelectric cooler via the support structure, conductive plate, and thermal conduit.

In any of the embodiments disclosed herein, the battery system can further comprise a second plurality of battery cells and a second support structure. The second plurality of battery cells can be disposed adjacent to a second side of the conductive plate. The second side can oppose the first side. The second support structure can be positioned between the second side of the conductive plate and the second plurality of battery cells. The second support structure can be configured to assist in the transfer of thermal energy generated by the second plurality of battery cells to the conductive plate.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIGS. 1A-B provide exemplary hybrid photovoltaic/storage grid coupling diagrams for AC (FIG. 1A) and DC (FIG. 1B) systems that can be used with some embodiments of the present disclosure.

FIG. 2 provides an exemplary microinverter high-level block diagram comprising of M 14S1P battery strings forming a pack, N photovoltaics (PVs) with their respective dc/dc converters, and an isolated dc/ac converter used in accordance with some embodiments of the present disclosure.

FIG. 3 provides an exploded view of a battery system, in accordance with some embodiments of the present disclosure.

FIGS. 4A-B provide an illustration of a battery modules (FIG. 4A) and a battery pack (FIG. 4B), in accordance with some embodiments of the present disclosure.

FIG. 5 provides a battery pack and vacuum panel case, in accordance with some embodiments of the present disclosure.

FIG. 6 provides an illustration of a Peltier junction module thermal interface with a battery pack, in accordance with some embodiments of the present disclosure.

FIG. 7 provides an exploded view of a vacuum insulation enclosure, in accordance with some embodiments of the present disclosure.

FIG. 8 provides a zoomed in view of a thermal insulating chamber, in accordance with some embodiments of the present disclosure.

FIG. 9 provides an exploded view of a battery system, in accordance with some embodiments of the present disclosure.

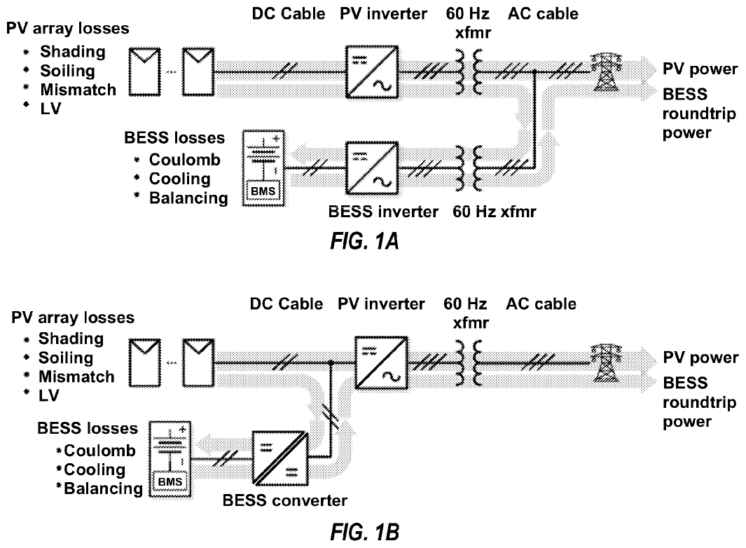

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As discussed above, to achieve further integration of solar energy into the grid, there is a need to realize battery packs with extended storage of, for example 3-6 hours, that can be integrated with PV panels to realize scalable hybrid PV solar systems or pure energy storage systems that directly connect to a bulk power system, such as an AC or DC grid. Of particular interest is the ability to realize long life for the battery pack in an outdoor environment, with outside temperatures ranging from, for example, −20° C. to +60° C. for extended periods of time. This disclosure addresses the thermal management of such outdoor battery packs.

Embodiments disclosed herein are capable of realizing long duration (e.g., 3-6 hours) of energy storage. For instance, consider a 2.7-kWh battery pack with a nominal power rating of 500-W and 1-kW peak. This would provide 2.7 to 5.4 hours of energy storage and could be used along with PV panels and the grid to provide a flexible and dispatchable generation grid resource. Such a pack could be built with 140 32700 LiFePO4 cells of 6-Ah capacity at 3.2-V nominal. Operating at 500-W, the batteries would be at C/6 charge/discharge rate and at C/3 at 1-kW. This is a very low charge/discharge rate than is often used with Lithium cells in other applications, where their ability to operate at high C rates is generally of interest.

The low-C-rate operation of the batteries can have a significant impact on the thermal design of the overall pack. Taking a typical LiFePO₄ cell, it can be seen that at a C/3 operating condition, the dissipation in each battery can be ˜0.045-W and approximately 0.011-W at a C/6 rate. This translates into approximately 5.6-W of maximum total dissipation that needs to be managed for the entire pack under nominal conditions. At a higher 3C level, as may be seen in some automotive applications, the power dissipation per battery could be >3.6-W per cell or 500-W at the pack level, which represents a much more challenging thermal management problem.

The approximate mechanical dimension of the typical 2.7-kWh battery pack described above is around 20″×18″×3″. The overall battery module can be located in the outside environment and can be subjected to a widely varying ambient temperature range from, for example, −20° C. to +60° C. With such an expansive surface of about 720 square inches available, heat flow between the battery and the environment can pose a much bigger problem than handling battery thermal losses. With a typical thermal resistance of 1-W/° K. for the aluminum battery housing and a temperature difference of 40°° C. between the environment and the desired battery temperature, it can be seen that as much as 80-W of heat flows are to be managed if the battery temperature is to be maintained and long life realized. This is in sharp contrast to the 5.6-W of battery internal thermal heating to be managed.

Accordingly, it can be more important, not get heat out of the battery to the environment, but rather to prevent heat from the environment from getting to the battery. It is desirable to maintain the battery at an optimal temperature, managing individual cells so they remain safe and that battery life is maximized, and to do so for extended periods of time. Once this “thermal isolation” of the battery pack is achieved, it is also desirable to safely be able to regulate the temperature of the battery pack while managing the internal losses that the batteries experience. This changes the thermal design problem substantially.

Further, to minimize the risk of thermal runaways and fires, it is desirable for batteries to not be able to dump energy into a degraded cell, causing it to overheat and catch fire. This may suggest that battery cells not be paralleled. Further, in case an individual battery suffers explosive venting, it is desirable for the battery to not be positioned so that it can cause a thermal runaway in a neighboring cell. Thus, it is desirable for batteries to be positioned such that an explosion, if it occurs, is directed away from other batteries. Further, at the system level, it is desirable for battery modules to be located far enough from other packs, so that a fire, if it happens, is localized to a single battery pack and cannot propagate.

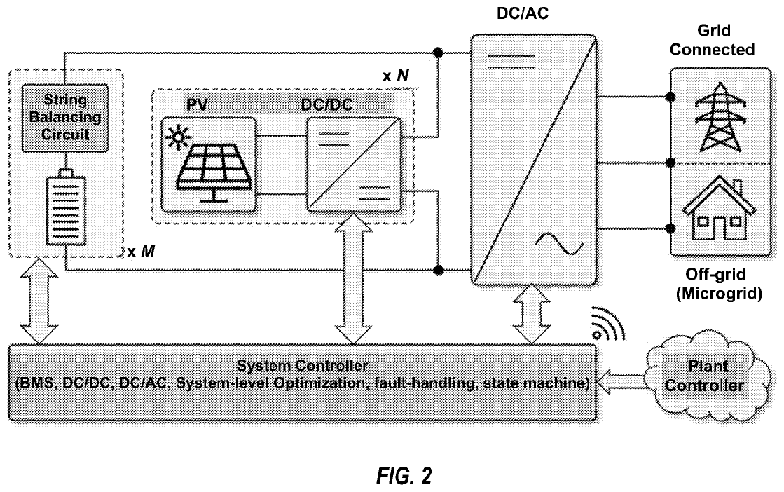

In addition, to manage battery life and allow the battery pack to be touch-safe, it can be desirable to reduce the battery stack to a lower voltage (e.g., 48-V with 14 series connected cells) with fewer series connected cells. It can also be desirable for no battery cells to be connected in parallel to avoid battery life degradation. Individual series strings (i.e., 14S1P configuration) can be monitored for degradation of any single cell, and current to the string can be throttled if such degradation is found by a string balancing circuit. By configuring the battery stack (i.e., 10×14SP1, 14S10P for the full pack) and battery management system (BMS) system as discussed here (and as shown in FIG. 2), battery module life can be extended to the maximum extent possible. However, managing the thermal environment for the battery under all possible operating conditions remains a big challenge. Embodiments disclosed below address this challenge.

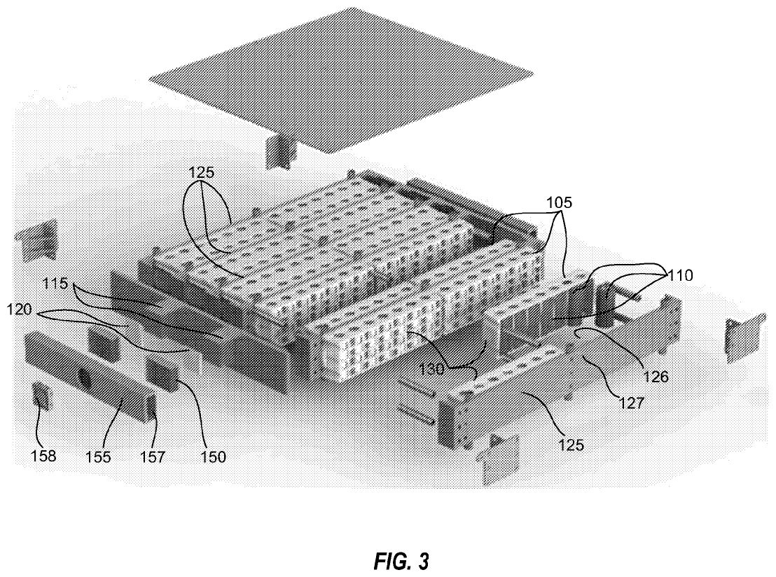

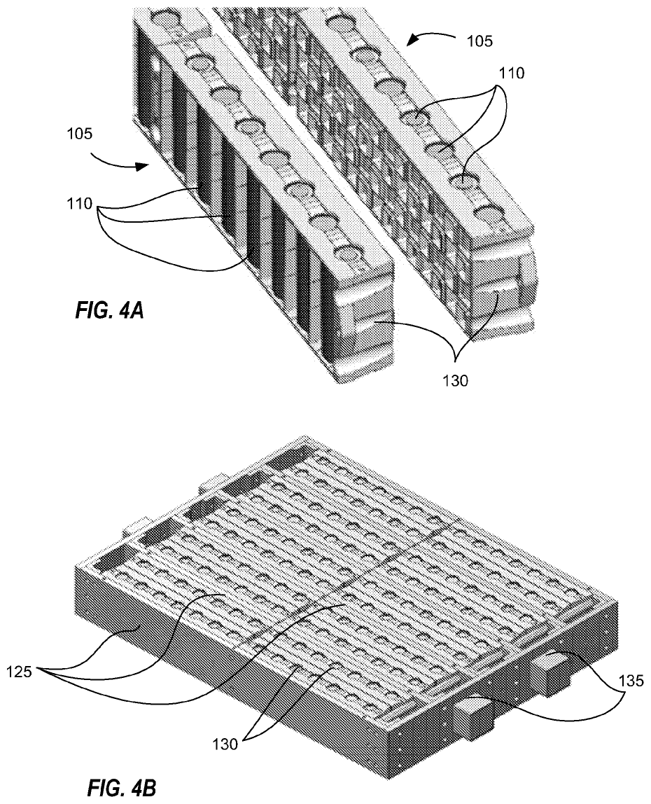

As shown in FIG. 3, an exemplary embodiment of the present disclosure provides a battery system comprising one or more battery modules 105, one or more thermal conduits 115, and one or more thermoelectric coolers 120. As shown in FIG. 4A, each of the one or more battery modules 105 can comprise a plurality of batteries 110. The batteries can be many different batteries known in the art, including, but not limited to lithium-ion batteries. As shown in FIG. 4A, each of the one or more battery modules 105 can further include a support structure 130, that can mechanically anchor the batteries with respect to each other in the battery module. The support structure 130 can be made of many different materials. In some embodiments, the support structure 130 can be made of a thermally insulative material, which can assist in directing thermal energy from the batteries 110 to the conductive plates 125. In some embodiments, the support structure 130 can substantially surround the batteries 110. For example, as shown in FIG. 4A, the support structure 130 can have a honeycomb shape to support the batteries 110.

As shown in FIG. 4B, a conductive plate 125 can be positioned between adjacent battery modules 105. The conductive plate can be made of many different thermally conductive materials known in the art, including, but not limited to aluminum or other metals. The conductive plate 125 can have first 126 and second 127 sides. Batteries in a first battery module can be positioned adjacent a first side of the conductive plate, e.g., with the support structure 130 between the batteries 110 and the first side of the conductive plate 125, and batteries in a second battery module can be positioned adjacent to a second side of the conductive plate, e.g., with another support structure 130 between the batteries 110 and the second side of the conductive plate 125.

As shown in FIG. 4B, the one or more thermal conduits 115 can be coupled to the one or more battery modules 105, e.g. via the conductive plates 125. Further, the one or more thermoelectric coolers 120 can be coupled to the one or more thermal conduits 115. Thus, thermal heat generated by the batteries 110 can flow through the support structure 130, to the conductive plate 125, through the thermal conduits 115, and to the thermoelectric coolers 120. The thermoelectric coolers 120, e.g., Peltier junctions, can then to dissipate the thermal energy to control the temperature of the battery system.

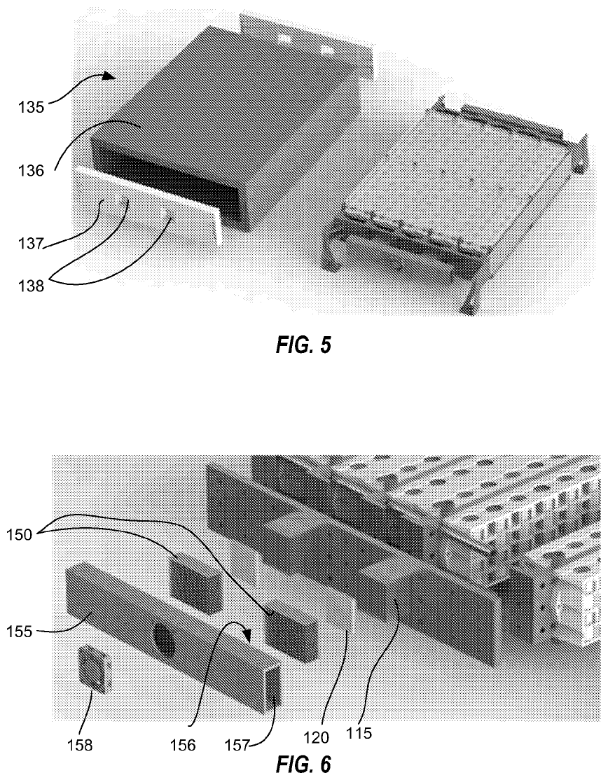

As shown in FIGS. 5, 7, and 9, the battery system can further comprise an insulator 135 surrounding at least a portion of the one or more battery modules 105. The insulator 135 can be configured to inhibit the flow of thermal energy between the plurality of batteries and an external environment to the battery system. Thus, the insulator 135 can serve to prevent heat from the external environment from reaching and affecting the temperature of the batteries 110. The insulator 135 can also serve to retain heat of the batteries 110, e.g., when the temperature in the external environment is cold. In some embodiments, the insulator can comprise an insulative sleeve 136 and side plates 137 that together substantially surround the battery modules. The insulator 135 (including the insulative sleeve 136 and side plates 137) can be made of many different insulative materials known in the art, including, but not limited to rigid polyurethane foam panels, vacuum panels, and the like. Dependent on the material of the insulator 135, the insulator 135 can have many different thermal conductivities ranging from 0.001-0.0025 W/(m·K).

As shown in FIG. 5, the side plates 137 can have one or more apertures 138 configured to receive the thermal conduits 115. Thus, the apertures 138 with thermal conduits 115 protruding therethrough allow provide a path for thermal energy to be transferred between the batteries 110 inside the insulator 135 and the exterior of the insulator 135.

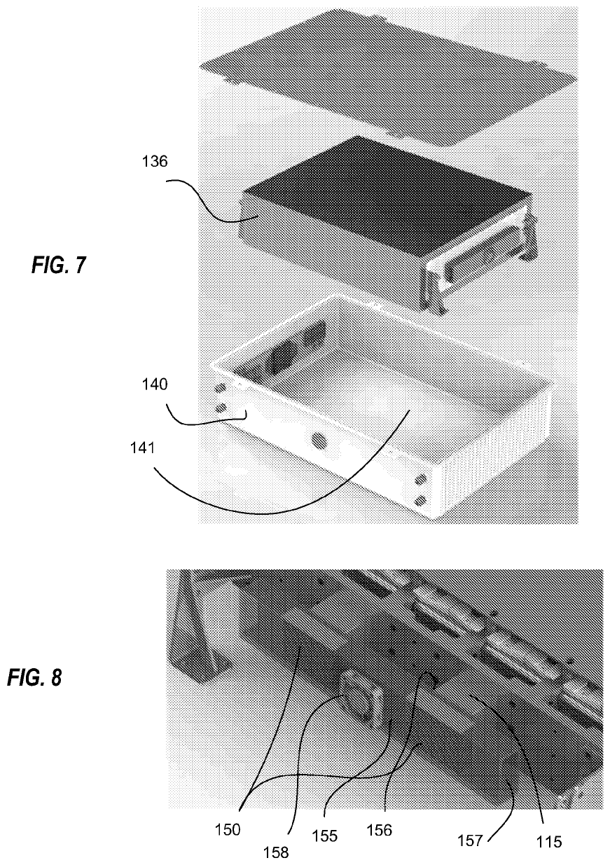

As shown in FIG. 7, the battery system can further comprise an enclosure 140 (e.g., housing) defining an interior volume 141. The enclosure can house the other components of the battery system. The interior volume 141 can contain the one or more battery modules 105, the one or more thermal conduits 115, the one or more thermoelectric coolers 120, and the insulator 135 (and other components of the battery system).

As shown in FIG. 6, the battery system can further comprise one or more heat sinks 150. The heat sinks 150 can be coupled to corresponding thermoelectric coolers 120. The heat sinks can receive thermal energy from the thermoelectric coolers and dissipate that thermal energy. The heat sinks can be many heat sinks known in the art.

As shown in FIG. 6, the battery system can further comprise a chamber 155 defining a substantially hollow internal cavity. The chamber 155 can comprise a plurality of openings 156 157. For example, the chamber can comprise a first opening 156 to receive a first heat sink. As shown in the figures, the chamber 155 can include additional openings to receive additional heat sinks. The chamber can also comprise a second opening in fluid communication with an external environment (e.g., an area external to the insulative sleeve and side plates). In some embodiments, the second opening can be located proximate an end of the chamber. In some embodiments, the chamber can have multiple openings in fluid communication with an external environment (e.g., at each end of the chamber). As also shown in FIG. 6, the chamber 155 can further comprise a fan 158 configured to generate airflow through the internal cavity of the chamber to discharge thermal energy from the heat sinks, through the second opening(s) 157, and to the external environment. The use of the chamber 155 with openings at the ends thereof can provide increased thermal isolation between the external environment and the batteries.

### EXAMPLES

Below certain exemplary embodiments are disclosed. These embodiments, however, should not be read as limiting the scope of the present disclosure.

Disclosed below is a 2.7-kWh (10×14S1P) battery pack, as shown in FIG. 3, which includes an active thermal management system that can be used to cool or heat the battery module as and when needed. There are several key features to the design. Given the low loss in a single battery cell when operated below C/3 (45-mW maximum), each battery can be coupled with a modest thermal resistance to a common aluminum plate. Even with a high thermal resistance of 10° C./W, the temperature difference between the plate and the battery can be <0.5° C., facilitating the active thermal management system design. A honeycomb structure of the type shown in FIG. 4A can be built to mechanically anchor the battery cells and to create the series stack of 14 batteries that constitutes the building block and can be replicated to achieve the desired kWh (e.g., ten building blocks are used in the exemplary design). More specifically, each honeycomb can be, in turn, anchored with the aluminum plates that provide both mechanical anchoring as well as the isothermal surface that fixes the temperature of all batteries mounted to it. In the design shown in FIG. 4B, there are a total of six plates that are used to anchor all the 140 cells used to form the 2.7-kWh battery pack.

The total battery pack/module can be encased in high thermal resistance vacuum panels, configured in an insulating sleeve with side plates, one implementation of which is as depicted in FIG. 5. The “isothermal” aluminum plates connect onto one or more “heat conduits” (also referred to as “thermal conduits”) that provide the path for possible heat flow between the battery pack and its outside, as shown in FIG. 4B. Other paths for heat flow can be thermally isolated to the best extent possible (e.g., through the use of vacuum panels).

As discussed above, a major challenge is a desire to keep the battery pack cool, at a temperature of, e.g., 30° C., when the environment is at 60° C. An analysis of a similar volume cavity showed that around ˜5-W of heat flow occurred between the environment and the “pack” through the tested vacuum packs. This suggests that even if there are no battery losses, it would be desirable to continuously remove 5-W of thermal power from the pack volume. Furthermore, if the batteries are active (i.e., charging/discharging), it would be desirable to remove 10.6-W continuously. A solution such as passive heating of phase change materials, with a limited amount of energy that can be absorbed, is limited in its ability to manage the battery temperature under all operating conditions.

Contrary to a passive thermal management solution, Peltier junctions can be used as thermoelectric coolers located on the “heat conduit” pads to be able to remove heat from the thermally insulated battery pack, as demonstrated in FIG. 6. Applying a controlled DC voltage to the Peltier junction cools the surface on which it is mounted, and transfers the heat to the other surface, from where it has to be managed.

The vacuum panel encased battery pack can be completely housed inside the sealed cabinet that is the overall mechanical housing, as depicted in FIG. 7. The outside heat sink of the Peltier junction can be completely encased in a thermally insulating cavity (as shown in FIG. 8 in red). Under nominal conditions, when the battery pack is within a desired temperature band, the only heat exchange is between the battery pack and the inside of the mechanical case, most of which occurs through the vacuum panels (estimate maximum of 5 to 10-W with a 30° C. temperature difference and maximum battery losses). When the battery temperature increases, and needs to be regulated, the Peltier can be turned on and a heat exchange mechanism such as a long-life small fan or pulsating diaphragm device (such as a loudspeaker or Synjet) can be used to cool the Peltier junction, transferring heat via convection to the inside of the mechanical housing. This can allow low thermal resistance when the airflow is activated, but a high thermal resistance when it is off. This functionality can allow the battery pack to be maintained within a desired temperature band without continuous and sustained power losses.

While the Peltier junction can be used to both heat and cool the battery pack, the pack can also be heated using resistive heating of around 5- to 10-W, minimizing the use of the convective cooling mechanism. Between the internal heat generated by the batteries and the resistive heating elements, the heat flow can be countered when the external environment is cold. It should be noted that the heat can be transferred to the inside of the mechanical housing, and that air can be between the battery housing and the exterior of the mechanical housing. This air barrier can also pose high thermal resistance and further limit heat losses/gain by the battery pack.

A key factor in the overall design and operation of the exemplary active thermal management system can be the impact that the battery module thermal inertia has on the system. The battery and its structural elements can represent around 70-lbs of weight and significant thermal capacity. In a properly insulated environment, the module can stay warm or cold for a day or more without external heating or cooling. Thus, precooling or preheating can be performed on the battery pack, and the cost and temperature deviations can be optimized, based on solar, temperature, and load forecasts. A passive cooling system cannot provide this level of flexibility and performance. However, typical active thermal management systems cannot realize long life and operation without maintenance. The proposed approach can achieve both.

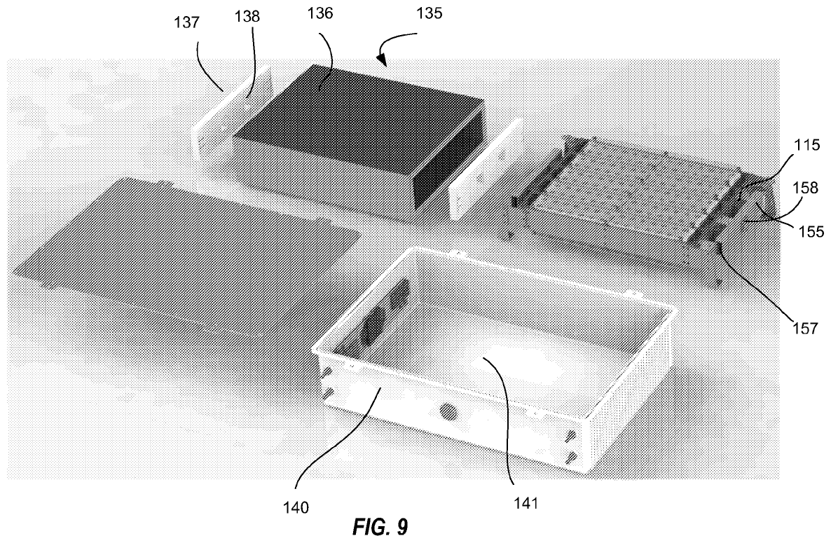

Additionally, the power converter elements, including the PV panel conditioners, battery string isolation and DC/AC inverter, are located that allows the hybrid solar-storage system to operate grid-connected (see FIG. 9). Assuming a typical 97% efficiency for the power conversion gives a total loss budget of around 30W at 1-kW input/output, or 15-W at 500-W. A significant part of this loss can be directly coupled to the mechanical housing, but it can be assumed that around 10-W can be coupled into the air. Including battery, Synjet/fan, battery management system (“BMS”) and power converter losses, it can be estimated around 25-W of losses are added to the inside of the mechanical housing. These losses can be exchanged with the outside environment. Given that the surface area of the mechanical housing (including power converters and battery pack) can be more than 800 square inches, an effective thermal resistance estimated to be around 0.2° C./W can be seen, which provides for around a 5° C. temperature differential between the air outside and inside the cabinet caused by the 25-W of losses inside the cabinet. The presence of the Synjet/fan can also set up mixing of the air that equalizes the temperature inside the cabinet. The only wires into or out of the mechanical housing can be for connection to PV panels or to the grid-the mechanical housing can be otherwise sealed.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A battery system comprising:
a battery module comprising:
a conductive plate having a first side and a second side;
a first portion of battery cells disposed adjacent to the first side of the conductive plate; and
a first support structure positioned between the first side of the conductive plate and the first portion of battery cells;
wherein the first support structure is configured to assist in directing thermal energy generated by the first portion of battery cells to the conductive plate;
a thermal conduit coupled to the battery module; and
a thermoelectric cooler coupled to the thermal conduit;
wherein:
the thermal conduit is configured to allow thermal energy to flow from the battery module to the thermoelectric cooler; and
the thermoelectric cooler is configured to dissipate thermal energy generated by the battery module.

2. (canceled)

3. The battery system of claim 1, wherein the battery module further comprises:
a second support structure positioned between, and in contact with, a second portion of the battery cells that are positioned adjacent to the second side of the conductive plate;
wherein the second support structure is configured to allow thermal energy generated by the second portion of battery cells to flow to the conductive plate.

4. (canceled)

5. The battery system of claim 3 further comprising:
an insulator surrounding at least a portion of the battery module.

6. The battery system of claim 5, wherein the insulator is configured to inhibit the flow of thermal energy between the battery cells and an external environment to the battery system.

7. A battery system comprising:
one or more battery modules, each of the battery modules comprising:
a conductive plate having a first side and a second side;
a first portion of battery cells disposed adjacent to the first side of the conductive plate; and
a first support structure positioned between the first side of the conductive plate and the first portion of battery cells;
wherein the first support structure is configured to assist in directing thermal energy generated by the first portion of battery cells to the conductive plate;
an insulator surrounding at least a portion of the battery modules;
one or more thermal conduits coupled to one or more of the battery modules;
one or more thermoelectric coolers coupled to one or more of the thermal conduits; and
an enclosure defining an interior volume containing one or more of the battery modules, one or more of the thermal conduits, one or more of the thermoelectric coolers, and the insulator;
wherein:
one or more of the thermal conduits are configured to allow thermal energy to flow from one or more of the battery modules to one or more of the thermoelectric coolers;
one or more of the thermoelectric coolers are configured to dissipate thermal energy generated by one or more of the battery modules; and
the insulator is configured to inhibit the flow of thermal energy between the first portion of battery cells and an external environment to the battery system.

8. The battery system of claim 7, wherein the insulator comprises vacuum panels having a thermal conductivity of 0.001-0.0025 W/(m·K).

9. The battery system of claim 7, wherein the interior volume of the enclosure contains each of the battery modules, the thermal conduits, the thermoelectric coolers, and the insulator.

10. The battery system of claim 7, wherein the insulator comprises an insulative sleeve and side plates comprise one or more apertures configured to receive one or more of the thermal conduits.

11. (canceled)

12. The battery system of claim 7, wherein one or more of the thermoelectric coolers comprise a Peltier junction.

13. The battery system of claim 7 further comprising:
one or more heat sinks;
wherein a respective one of the heat sinks is coupled to a respective one of the thermoelectric coolers.

14.-16. (canceled)

17. The battery system of claim 7, wherein the battery system is configured to generate a voltage level in the range of 24 to 48 volts.

18. (canceled)

19. The battery system of claim 7, wherein each of the battery modules further comprises:
a second portion of battery cells disposed adjacent to the second side of the conductive plate, the second side opposing the first side; and
a second support structure positioned between the second side of the conductive plate and the second portion of battery cells;
wherein the second support structure is configured to assist in directing thermal energy generated by the second portion of battery cells to the conductive plate.

20. The battery system of claim 7, wherein the conductive plate comprises aluminum.

21.-25. (canceled)

26. The battery system of claim 7, wherein the insulator comprises an insulative sleeve and at least one side plate.

27. (canceled)

28. The battery system of claim 7, wherein each of the thermoelectric coolers comprises a Peltier junction.

29. (canceled)

30. The battery system of claim 13 further comprising;
a chamber defining a substantially hollow internal cavity;
wherein the chamber comprises:
one or more heat sink openings, each respective heat sink opening for receiving a respective one of the heat sinks; and
a second opening in fluid communication with an external environment.

31. The battery system of claim 30, wherein the second opening is located proximate an end of the chamber.

32. The battery system of claim 30, wherein the chamber further comprises:
a fan configured to generate airflow through the internal cavity to discharge thermal energy from one or more of the heat sinks, through the second opening, and to the external environment.

33. (canceled)
